(19) United States
(12) Patent Application Publication
(10) Pub. No.: US 2026/0163960 A1
(43) Pub. Date: Jun. 11, 2026

(54) O-RAN and Open 5G Core Network Unified Wireless and Wireline Dynamic Proxy

(71) Applicants: AT&T Intellectual Property I, L.P., Atlanta, GA (US); Interwise Ltd., Ben-Gurion Airport (IL)

(72) Inventors: Joseph Soryal, Glendale, NY (US); Eynat Weinberg Nordman, Ramat Hasharon (IL); Venson Shaw, Kirkland, WA (US)

(73) Assignees: AT&T Intellectual Property I, L.P., Atlanta, GA (US); Interwise Ltd., Ben-Gurion Airport (IL)

(21) Appl. No.: 18/977,252

(22) Filed: Dec. 11, 2024

(51) Int. Cl. H04L 67/56; H04L 41/16

(52) U.S. Cl. CPC H04L 67/56; H04L 41/16

(57) ABSTRACT

Aspects of the subject disclosure may include, for example, instantiating, on a communications system, a first master digital proxy associated with a first user; identifying a first plurality of digital proxies, other than the first master digital proxy, that are on the communications system and that are associated with the first user; responsive to the identifying, configuring the first master digital proxy for bi-directional communications with each of the first plurality of digital proxies; determining movement of the first user, wherein the determining the movement of the first user comprises determining that a first user device being used by the first user has moved to communicating with a current network node of the communications system; and responsive to the determining the movement of the first user, moving at least part of the first master digital proxy to the current network node of the communications system. Other embodiments are disclosed.

### FIELD OF THE DISCLOSURE

The subject disclosure relates to an O-RAN and open 5G core network unified wireless and wireline dynamic proxy.

### BACKGROUND

It is expected that via implementation of generative AI models, each human user (for example, each human user of a communications system) will have multiple AI-powered digital proxies for various tasks in life. Eventually, each human user will likely have a digital proxy for work, a digital proxy for school, a digital proxy for banking, a digital proxy for health care, etc.

### BRIEF DESCRIPTION OF THE DRAWINGS

Reference will now be made to the accompanying drawings, which are not necessarily drawn to scale, and wherein:

FIG. 1 is a block diagram illustrating an example, non-limiting embodiment of a communication network in accordance with various aspects described herein.

FIG. 2A is a block diagram illustrating an example, non-limiting embodiment of a system (which can function within the communication network of FIG. 1) in accordance with various aspects described herein.

FIG. 2B is a block diagram illustrating an example, non-limiting embodiment of a system (which can function within the communication network of FIG. 1) in accordance with various aspects described herein.

FIG. 2C depicts an illustrative embodiment of a method in accordance with various aspects described herein.

FIG. 2D depicts an illustrative embodiment of a method in accordance with various aspects described herein.

FIG. 2E depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for a secure AI-Digital Proxy (sometimes referred to herein as “sAIp”) that can always be in the proximity of an associated human user and that acts as a digital “bodyguard” to ensure that all other digital proxies follow the intent and/or direction of the human user. Other embodiments are described in the subject disclosure.

One or more aspects of the subject disclosure include a device, comprising: a processing system including a processor; and a memory that stores executable instructions that, when executed by the processing system, facilitate performance of operations, the operations comprising: instantiating, on a communications system, a first master digital proxy associated with a first user; identifying a first plurality of digital proxies, other than the first master digital proxy, that are on the communications system and that are associated with the first user; responsive to the identifying, configuring the first master digital proxy for bi-directional communications with each of the first plurality of digital proxies; determining movement of the first user, wherein the determining the movement of the first user comprises determining that a first user device being used by the first user has moved to communicating with a current network node of the communications system; and responsive to the determining the movement of the first user, moving at least part of the first master digital proxy to the current network node of the communications system.

One or more aspects of the subject disclosure include a non-transitory machine-readable medium comprising executable instructions that, when executed by a processing system including a processor, facilitate performance of operations, the operations comprising: configuring, on a communications system, a first master digital proxy associated with a first user, wherein the first master digital proxy is configured for first bi-directional communications with each of a first plurality of digital proxies that are associated with the first user; configuring, on the communications system, a second master digital proxy associated with a second user, wherein the second master digital proxy is configured for second bi-directional communications with each of a second plurality of digital proxies that are associated with the second user; tracking movement of the first user; responsive to the tracking of the movement of the first user, relocating all or part of the first master digital proxy to a first target network node of the communications system that is in proximity to the first user; tracking movement of the second user; and responsive to the tracking of the movement of the second user, relocating all or part of the second master digital proxy to a second target network node of the communications system that is in proximity to the second user.

One or more aspects of the subject disclosure include a method, comprising: tracking, by a processing system including a processor, first movement of a user of a communications network, wherein the tracking of the first movement results in a first determined location of the user; responsive to the tracking of the first movement of the user, relocating by the processing system all or part of a master digital proxy to a first network node of the communications network that is in proximity to the first determined location, wherein the master digital proxy is configured for oversight of each of a plurality of digital proxies that are associated with the user; tracking, by the processing system, second movement of the user, wherein the tracking of the second movement results in a second determined location of the user; and responsive to the tracking of the second movement of the user, relocating by the processing system all or part of the master digital proxy to a second network node of the communications network that is in proximity to the second determined location.

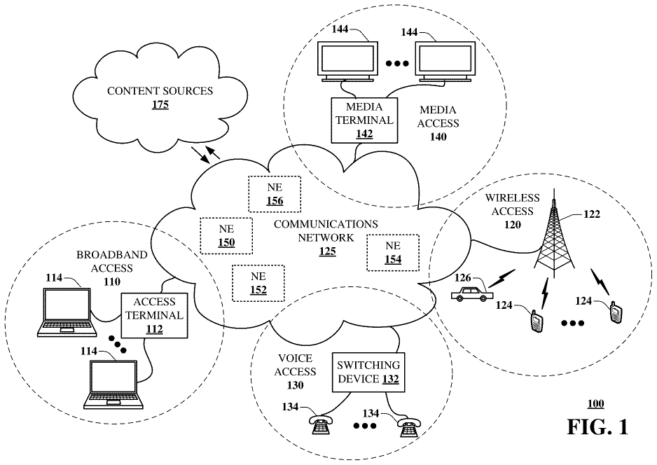

Referring now to FIG. 1, a block diagram is shown illustrating an example, non-limiting embodiment of a system 100 in accordance with various aspects described herein. For example, system 100 can facilitate in whole or in part unified wireless and wireline dynamic proxies (including, for example, a “bodyguard” (or master) digital proxy that interfaces with one or more other digital proxies and that follows a human user in the physical world and/or logically throughout a communications network). In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

As described herein, various embodiments provide a secure AI-Digital Proxy (sometimes referred to herein as “sAIp”) that can always be in the proximity of an associated human user and that acts as a digital “bodyguard” to ensure that all other digital proxies follow the intent and/or direction of the human user. In one embodiment, the sAIp can have a plurality of interfaces to monitor all other digital proxies (and their transactions), and another interface to the user (which interface can be, for example, uninterrupted). In one embodiment, the sAIp can continually move closer to the user and can reside on the nearest RAN on the hardware platform next to the vRAN (while connecting to the backend server that can reside on the core and/or a private/public cloud). In one embodiment, the sAIp can summarize any transaction and send it to the user's device (e.g., in case the user did not initiate or authorize this transaction). In one embodiment, the sAIp can hold all relevant the information regarding (e.g., such as to be able to simulate the thought process of the user and to act as a dynamic autonomous firewall for any non-aligned transaction that is conducted (or attempted to be conducted) by a digital proxy. In one embodiment, the sAIp can work 24/7 in the background (e.g., not only when the user requests an action/transaction).

As described herein, various embodiments can facilitate orchestration and/or business transactions (e.g., where security is needed).

As described herein, various embodiments can facilitate operations interfacing with the BBU (wireless baseband unit) on the RAN/ORAN and/or on the fiber optic system (such as optical switches and ONU (optical network unit) and OLT (optical line terminal)).

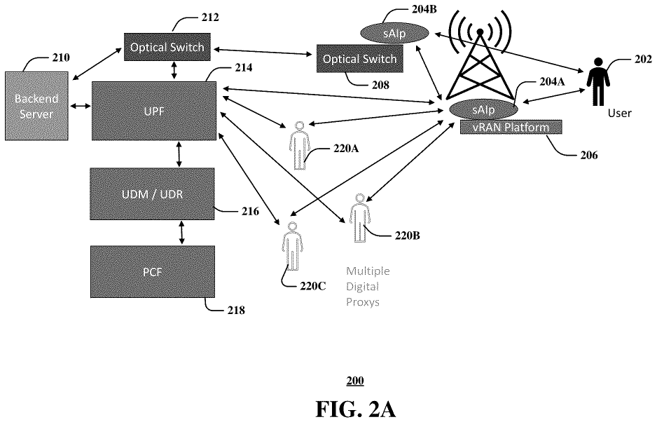

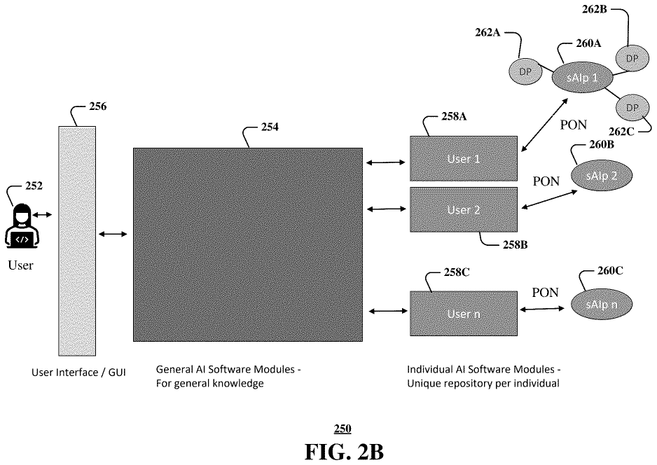

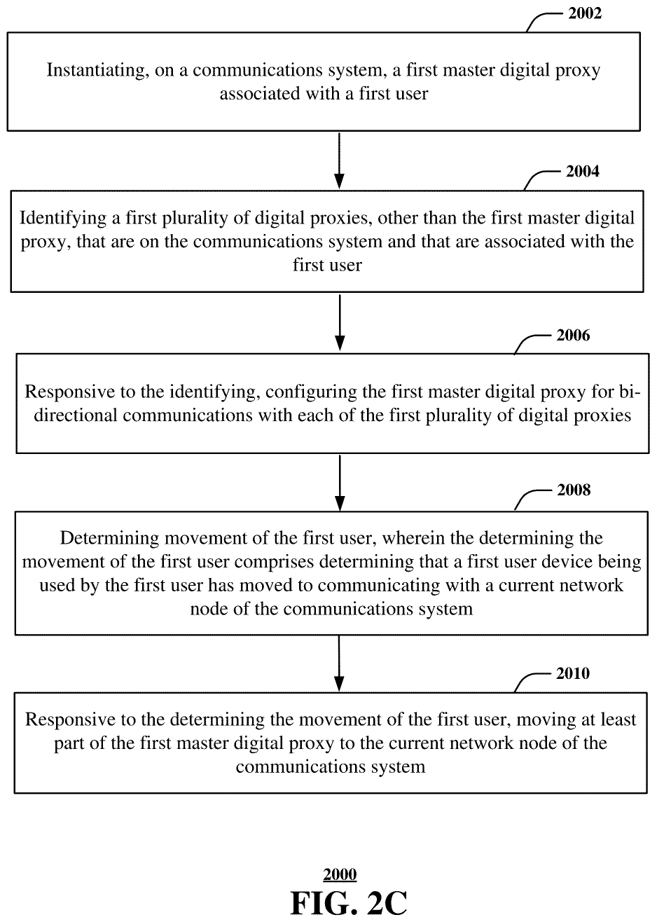

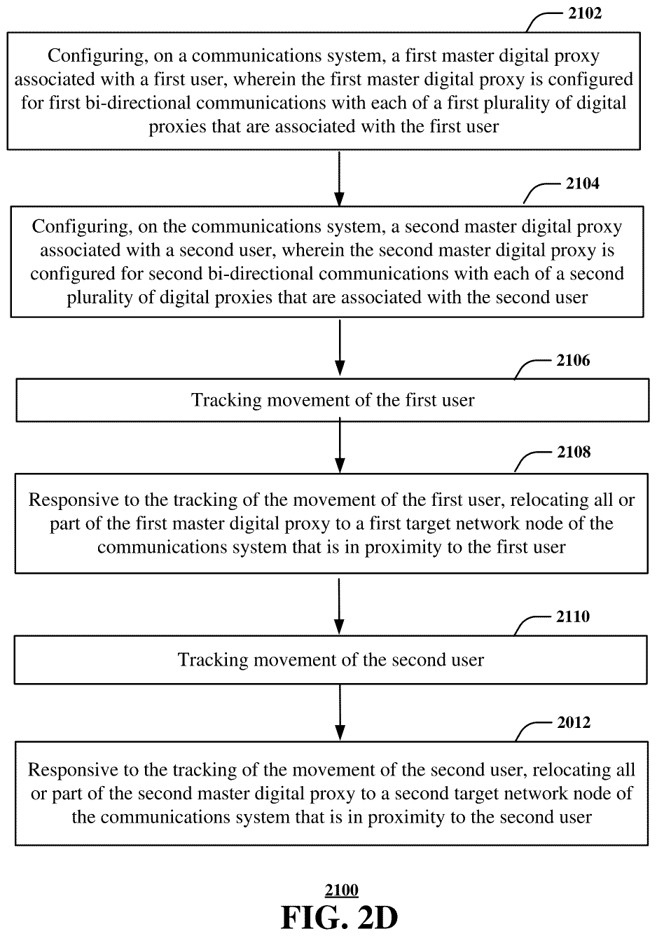

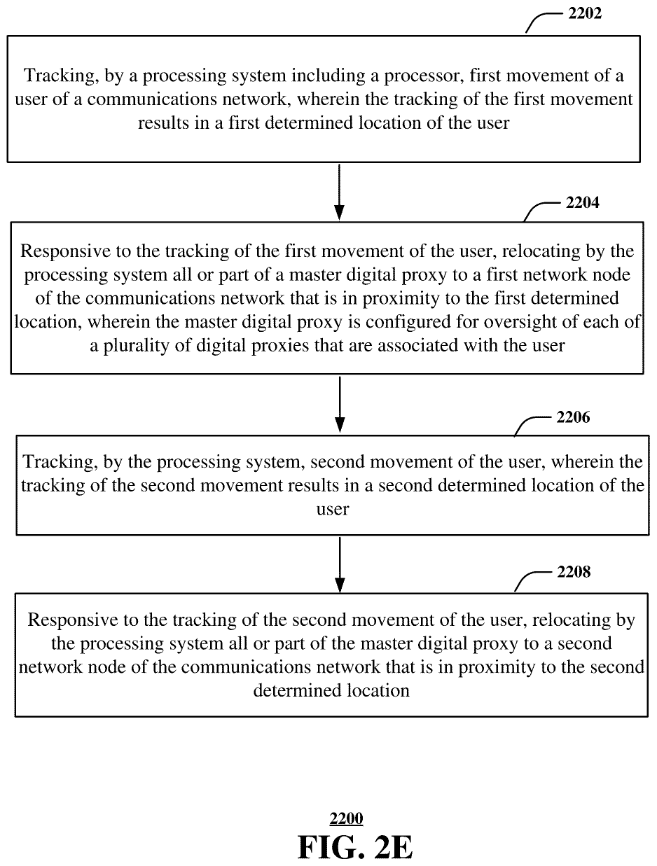

Referring now to FIG. 2A, this is a block diagram illustrating an example, non-limiting embodiment of a system 200 (which can function within the communication network of FIG. 1) in accordance with various aspects described herein. As seen in this figure, user 202 (who is operating an end-user device, not shown) can have bi-directional communications (via the end-user device) with sAIp 204A and sAIp 204B. The sAIp 204A is located on vRAN platform 206 and the sAIp 204B is located on optical switch 208. The communications between the end-user device and each of vRAN platform 206 and optical switch 208 can comprise wireless communications, wired communications, or any combination thereof. In various examples, the end-user device can comprise a smartphone, a cellphone, a tablet computer, a laptop computer, a notebook computer, or any combination thereof.

Still referring to FIG. 2A, backend server 210 (which is discussed in more detail below) is configured for bi-directional communications with optical switch 212 and UPF (user plane function) 214. In addition, UPF 214 is configured for bi-directional communications with optical switch 212, and with UDM/UDR (unified data management/unified data repository) 216. UDM/UDR 216 in turn is configured for bi-directional communications with PCF (policy control function) 218. Moreover, UPF 214 is configured for bi-directional communications with each of digital proxies 220A, 220B, 220C. Further, each of digital proxies 220A, 220B, 220C is configured for bi-directional communications (directly or indirectly) with sAIp 204A and sAIp 204B. Finally, additional bi-directional communications are available as shown by the arrows in the figure. Of course, while one user is shown in this figure, any desired number of users can be supported. Similarly, while three digital proxies are shown in this figure, any desired number of digital proxies can be supported.

Still referring to FIG. 2A, an embodiment related to operational call flows can be as follows: (1) User (which can be a subscriber, a customer, or the like) joins the service and gets provisioned in the backend server 210. (2) The user's information gets inserted in the UDM/UDR 216 and PCF 218. (3) The user moves to a place and the user needs an sAIp instance. (4) The backend server 210 will: (a) consult the PCF 218 to review the policy associated with this user and determine how much resources they can get on the vRAN platform 206; and (b) then dip into the UDM/UDR 216 for the collection of records including location information. (5) Then backend server 210 will “spin up” (or instantiate) the sAIp on the closest RAN to the actual location of the user.

Still referring to FIG. 2A, in various embodiments, backend server 210 can be where all user profiles, digital proxy configurations, and digital proxy transactions reside. The backend server 210 can be responsible for billing and monitoring for some anomalies (however, the sAIp can be the first line of defense and can provide a security digital proxy assistant role to users in their proximity). Each sAIp can have unrestricted access to a corresponding user's device and can understand the totality of circumstances for a particular user (at the same time, each sAIp can monitor the proxies and their transactions). Each sAIp can anticipate the appropriate behavior of each monitored digital proxy. Each digital proxy is configured to provide the corresponding sAIp with all the relevant details (e.g., proposed transaction details). An sAIp can (in certain embodiments) transact directly (e.g., bypassing a digital proxy) and/or can query a transaction to validate its authorization/authentication level(s).

Referring now to FIG. 2B, this is a block diagram illustrating an example, non-limiting embodiment of a system 250 (which can function within the communication network of FIG. 1) in accordance with various aspects described herein. As seen in this figure, user 252 (who is operating an end-user device, not shown) can have bi-directional communications (via the end-user device) with one or more general AI software modules 254. These communications with the one or more general AI software modules 254 can be through user interface/GUI 256. In addition, the one or more general AI software modules 254 can have bi-directional communications with each individual AI software module 258A, 258B, 258C. In various embodiments, the one or more general AI software modules 254 can be for obtaining general knowledge and each individual AI software module 258A, 258B, 258C can comprise a unique repository per user. Further, each individual AI software module 258A, 258B, 258C can have bi-directional communications (via a respective PON (passive optical network) with a respective one of sAIp 260A, 260B, 260C. As seen, in this example, sAIp 260A is associated with each of digital proxy 262A, 262B, 262C. The communications between the end-user device and each of the one or more general AI software modules 256 can comprise wireless communications, wired communications, or any combination thereof. In various examples, the end-user device can comprise a smartphone, a cellphone, a tablet computer, a laptop computer, a notebook computer, or any combination thereof. Of course, while one user is shown in this figure, any desired number of users can be supported. Moreover, any desired number of general AI software modules can be supported. Likewise, while three individual AI software modules are shown in this figure, any desired number of individual AI software modules can be supported. Similarly, while three sAIp are shown in this figure, any desired number of sAIp can be supported. Further, while three digital proxies are shown in this figure, any desired number of digital proxies can be supported. Further still, each sAIp could have any number of digital proxies associated therewith.

Reference will now be made to an operations mechanism according to an embodiment. More particularly, this operations mechanism can be as follows: User gets the service of having multiple digital proxies from a service provider. The service provider offers the security/monitoring/validation service via creating an instance (e.g., of an sAIp) that follows the user wherever they go via spinning up a very light security engine on the vRAN platform in the RAN attached to the user phone via the strongest signal which can move from cell site to another and in this case the sAIp will move to the same cell site the UE is attached to. The light security engine can be a (FaaS) Function as a Service (Serverless Architecture) element where the security function is orchestrated and spun up on an application agnostic hardware. The FaaS can have individualized elements for security where the FaaS includes intimate knowledge about the individual circumstances and events and then provides security accordingly. The backend server can temporarily spin up these sAIp instances for each user based on their proximity and clears them right after the user had moved to another cell site attaching based on signal level and quality (RSRP and QRSP) parameters. A given sAIp is attached to the BBU (Baseband unit) and there is a continuous communication line between a digital proxy app on a user device and the corresponding sAIp. The digital proxy app on a given user device can allow the corresponding user to create and configure multiple digital proxies and their interactions. Each digital proxy (which should act in the best interest of a corresponding user) can be a software agent that resides on cloud/third party, etc.

Reference will now be made to privacy protection behavior according to an embodiment. More particularly, this privacy protection behavior can be as follows: Each digital proxy would conceal the real intent from other digital proxies and third parties and would only reveal need to know info. Location is obscured for the user so the digital proxies would not reveal the location of the user (unless, for example, the location is a critical component and in the essence of the digital proxy function/role/transaction). The digital proxy would get a feed from the RAN's GPS for location accuracy combined with the UE's GPS reading (e.g., so the sAIp is aware of the locations of the elements of the system for each individual). The digital proxy can have the ability to have multiple faces (e.g., public/private) wherein the public face can interact with the public where it can introduce itself and divulge information while the private face interacts only with pre-known entities and divulges only critical information for the task on hand.

Reference will now be made to a location mechanism according to an embodiment. More particularly, this location mechanism can be as follows: One or more digital proxies can be tied to a corresponding location. Each location can be tracked as to where the software application of the digital proxy resides (this location can be made as one of the defining parameters). An sAIp can have a location module that can define the exact location via a feed from the exiting GPS signal collocated with the baseband unit. In addition (or in the alternative) an sAIp can crowdsource the location from nearby devices that are willing to share the geographical location (such as autonomous vehicle which may be required to share their exact location to nearby devices).

Reference will now be made to a digital twin mechanism according to an embodiment. In such a digital twin embodiment, an sAIp can create a full digital twin (DT) corresponding to the user that compromises all digital proxies. More particularly, this digital twin mechanism can have all the following aspects: (a) A copy that contains information regarding the user's devices, so for example, a DT will have all the apps and phone configurations which can have many potential applications such as recovery, and/or control of the devices while a device is physically away. Anomaly detection can be applied wherein a security module can scrub the digital twin and preform a scan on it instead on actually disrupting the phone and running the scan directly on the device. (b) A copy of the user's health information (e.g., including allergies and medicine interaction). The DT could watch over the medication times. A user can consult regarding allergies and conflicting foods and other meds. (c) A copy of the user's social interactions (e.g., to validate communications made by devices to establish a link), (d) A copy for work persona can send meeting invites and prioritize meetings and tasks.

As described herein, various embodiments can facilitate wireline/wireless convergence (e.g., integrating with backhaul optical networks). In this regard, besides (or in addition to) hosting an sAIp on the vRAN, the backhaul fiber connection electronics can be utilized for this purpose. In one specific example (which example is intended to be illustrative and not restrictive) the connection between the individual generative AI software modules that reside on a network carrier public core and an sAIp that resides on the RAN can be the same backhaul fiber connection between the RAN sites and the network carrier public core. In one specific example (which example is intended to be illustrative and not restrictive) the architecture can integrate an sAIp on one or more optical switches (e.g., as a temporary software module on Software Defined Switches if there are available hardware resources). In one specific example (which example is intended to be illustrative and not restrictive) an instance of an sAIp can reside on a home WiFi connected to a network carrier Dedicated Fiber.

Reference will now be made to an example use case according to an embodiment. More particularly, this use case can be as follows: A network architect that works on multiple projects with a cellular carrier would have multiple digital proxies (for instance, one for each project). The digital proxies in this case would have intimate knowledge about the engineer's work on similar projects. Each digital proxy would design each project as per the network architect's principals and method of design (e.g., wherein the sAIp would monitor the digital proxy designing and executing the project to ensure that the design is matching the network architect's identity). The sAIp would intervene where the sAIp determines that the digital proxy may be deviating from the spirit of design and would alert the network architect to provide their input (for example, in a scenario where the digital proxy commands a specific system to construct a software interface for API queries, the sAIp, would allow the digital proxy to conduct this transaction only (e.g., via providing appropriate keys), if the sAIp believes the transaction matches the designer methods and intent).

As described herein, various embodiments provide mechanisms to help ensure that digital proxies operate in each user's best interest by: (a) preventing spoofing and ensuring proper authentication; (b) requiring explicit authorization from the user before taking action; and/or (c) coordinating seamlessly between wireless and optical networks.

As described herein, various embodiments provide mechanisms to help ensure that a digital proxy is not “going rogue” and is not conducting transaction(s) against the best interest of the user. In various embodiments, each AI digital proxy must operate in a secure architecture as follows: (a) is not spoofing another user and is properly authenticated; (b) is not taking action without proper specific authorization from the human user; and (c) coordinates between a service on the wireless network and on the optical network.

As described herein, various embodiments provide mechanisms for an entity (e.g., a communications carrier and/or service prodder) to help ensure that transactions are valid. A system (according to various embodiments) can serve as a safeguard to uphold various design principles established by the organization. For instance, such system can provide safeguards in the context of digital proxies that incorporate multiple layers of information (the safeguards can relate to company-wide regulations, organizational guidelines, group directives, and/or individual preferences).

As described herein, various embodiments provide mechanisms to automate a quality assurance (QA) process and/or to perform a check for the agile methodology and CI/CD framework.

As described herein, various embodiments provide mechanisms to: (a) enhance productivity and potentially save labor hours; (b) improve cost efficiency, potentially reducing the need for vendors and contractors; and/or (c) introduce new features to ORAN usage by offering location-based services (which could generate additional revenue).

As described herein, various embodiments provide mechanisms that can be implemented by telecommunication companies. For example, a telecommunication company can leverage AI-powered digital proxies to enhance customer experience by automating routine tasks, offering personalized services, and/or improving network management. These proxies can streamline operations, reduce costs, and enable more efficient use of network resources. Additionally, ensuring secure and authenticated communications can elevate the trust and reliability of their services, thereby attracting and retaining customers.

As described herein, various embodiments provide mechanisms that can be implemented by GenAI/LM companies. For example, companies specializing in generative AI and LLMs can benefit significantly by developing and deploying sophisticated AI-powered digital proxies. These proxies can serve as powerful tools to showcase the capabilities of their AI models in real-world applications. Various embodiments can address challenges related to security, authentication, and seamless coordination between different network types.

As described herein, various embodiments provide mechanisms that can be implemented by security companies. For example, security companies can play a crucial role in ensuring that AI-powered digital proxies operate safely and securely. They can develop (according to various embodiments) advanced authentication mechanisms, intrusion detection systems, and/or real-time monitoring tools to prevent unauthorized actions and spoofing. By providing these security solutions, they can help protect user data and transactions, making digital interactions more secure.

As described herein, various embodiments provide mechanisms to cooperate with the BBU (wireless baseband unit) on the RAN/ORAN and with the fiber optic electronics (such as optical switches and ONU and OLT) to provide authentication service.

As described herein, various embodiments provide mechanisms that are facilitated by the wireline/wireless convergence.

As described herein, various embodiments provide mechanisms to sanitize the output for next generation AI, wherein the output will have the ability to connect to other systems to conduct transactions inside the network.

As described herein, various embodiments provide mechanisms to facilitate virtualizing the RAN platform and segregating the hardware platform from the application level (e.g., baseband units). In one example, a platform can be implemented for location-based services.

As described herein, various embodiments provide mechanisms to enhance the security and functionality of an AI system (e.g., to generate work action items (e.g., design documents, system/network architecture etc.)). Such enhancement can enable the generation of documents as well as implementation of action items and plans in a secure, authenticated, and automated manner (e.g., while preserving individual identity). For example, in network architecture, if a specific architecture should be implemented instead of another one to save on QA efforts and programming later, the system can alert the user at the time of selection. The system can block the incorrect choice, provide a notification, and/or suggest the correct and relevant architecture.

As described herein, various embodiments provide mechanisms applicable to users, subscribers, customers, or the like.

As described herein, various embodiments provide an O-RAN and open 5G core network unified wireless and wireline dynamic proxy.

As described herein, various embodiments facilitate use of multiple proxies (which can be implemented, for example, as personas). Each proxy can have its own specialty (e.g., a proxy to talk to friends, a proxy to talk to co-workers, a proxy to talk to a work manager, etc.). Various embodiments can ensure that: (a) one of these proxies is not spoofing another user; (2) that each proxy is properly authenticated; and/or (3) that no proxy acts on its own in a malicious manner.

As described herein, various embodiments facilitate coordination between/among multiple proxies. For example (which example is intended to be illustrative and not restrictive), a person can have a medical proxy and a proxy that buys the person food. Information from each proxy can be used to impact transactions performed by the other (e.g., make sure that there will be no unacceptable food/medicine interactions). In one example (which example is intended to be illustrative and not restrictive) a proxy can receive prior training and/or can learn as transactions are performed.

As described herein, various embodiments can utilize generative AI to make one or more proxies and/or to learn from interactions between/among multiple proxies.

As described herein, various embodiments can learn as a user grows and ages. For example (which example is intended to be illustrative and not restrictive), a generative AI process can create a proxy for a user when the user is born. Aspects of the user's life can be fed into the proxy at various points in time.

As described herein, various embodiments can ensure that each digital proxy follows the intent and direction of a corresponding user. For example (which example is intended to be illustrative and not restrictive), an sAIp can detect that a potential purchase of a $20 cup of coffee is outside the normal purchase range of $2 or $3 (and the purchase of the $20 cup of coffee can be prohibited). In such a case of a prohibited transaction, an email, SMS, or the like can be sent to the user as a notification (and/or to request explicit permission to continue the transaction).

As described herein, various embodiments can facilitate creation of generative AI by a 5G (or later) communication system. For example (which example is intended to be illustrative and not restrictive), an sAIp (and/or a large language model (LLM)) can be

comprised of the interactions between/among different digital proxies.

As described herein, various embodiments can facilitate digital proxy implementation utilizing computational power of a vRAN and/or an optical network (e.g., comprising an optical switch). For example (which example is intended to be illustrative and not restrictive), a vRAN and/or an optical switch can provide computing power to do the generative AI processing.

As described herein, various embodiments can facilitate digital proxy implementation using function as a service, using a micro service, using an app, using a backend server, or any combination thereof. For example (which example is intended to be illustrative and not restrictive), a backend server can act as an orchestrator to create one or more sAIps on any platform.

As described herein, various embodiments can facilitate an sAIp that has unrestricted access to a user device and/or that can take over control of a transaction from a digital proxy. For example (which example is intended to be illustrative and not restrictive), an sAIp can instruct a backend server (e.g., via the cloud) to “unspin” (or take down) a misbehaving digital proxy.

As described herein, various embodiments can provide a mechanism via which location determination is performed by crowdsourcing (e.g., such that the location cannot be spoofed).

As described herein, various embodiments can provide a mechanism by which location of a user is tracked via family relationships and/or over time (e.g., based on most frequent (predominant) use of a given digital proxy).

Referring now to FIG. 2C, various steps of a method 2000 according to an embodiment are shown. As seen in this FIG. 2C, step 2002 comprises instantiating, on a communications system, a first master digital proxy associated with a first user. Next, step 2004 comprises identifying a first plurality of digital proxies, other than the first master digital proxy, that are on the communications system and that are associated with the first user. Next, step 2006 comprises responsive to the identifying, configuring the first master digital proxy for bi-directional communications with each of the first plurality of digital proxies. Next, step 2008 comprises determining movement of the first user, wherein the determining the movement of the first user comprises determining that a first user device being used by the first user has moved to communicating with a current network node of the communications system. Next, step 2010 comprises responsive to the determining the movement of the first user, moving at least part of the first master digital proxy to the current network node of the communications system.

While for purposes of simplicity of explanation, the respective processes are shown and described as a series of blocks in FIG. 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2D, various steps of a method 2100 according to an embodiment are shown. As seen in this FIG. 2D, step 2102 comprises configuring, on a communications system, a first master digital proxy associated with a first user, wherein the first master digital proxy is configured for first bi-directional communications with each of a first plurality of digital proxies that are associated with the first user. Next, step 2104 comprises configuring, on the communications system, a second master digital proxy associated with a second user, wherein the second master digital proxy is configured for second bi-directional communications with each of a second plurality of digital proxies that are associated with the second user. Next, step 2106 comprises tracking movement of the first user. Next, step 2108 comprises responsive to the tracking of the movement of the first user, relocating all or part of the first master digital proxy to a first target network node of the communications system that is in proximity to the first user. Next, step 2110 comprises tracking movement of the second user. Next, step 2112 comprises responsive to the tracking of the movement of the second user, relocating all or part of the second master digital proxy to a second target network node of the communications system that is in proximity to the second user.

While for purposes of simplicity of explanation, the respective processes are shown and described as a series of blocks in FIG. 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2E, various steps of a method 2200 according to an embodiment are shown. As seen in this FIG. 2E, step 2202 comprises tracking, by a processing system including a processor, first movement of a user of a communications network, wherein the tracking of the first movement results in a first determined location of the user. Next, step 2204 comprises responsive to the tracking of the first movement of the user, relocating by the processing system all or part of a master digital proxy to a first network node of the communications network that is in proximity to the first determined location, wherein the master digital proxy is configured for oversight of each of a plurality of digital proxies that are associated with the user. Next, step 2206 comprises tracking, by the processing system, second movement of the user, wherein the tracking of the second movement results in a second determined location of the user. Next, step 2208 comprises responsive to the tracking of the second movement of the user, relocating by the processing system all or part of the master digital proxy to a second network node of the communications network that is in proximity to the second determined location.

While for purposes of simplicity of explanation, the respective processes are shown and described as a series of blocks in FIG. 2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Reference will now be made to integrated machine learning (ML) and/or artificial intelligence (AI) that enables one or more network functions according to various embodiments. More particularly, since an sAIp (according to various embodiments) moves everywhere physically following the user, the sAIp can adapt to cultural variation without being deceived or misled (e.g., when it moves to different locations or when a digital proxy interacts with users/systems from different cultures). In various embodiments, the adaptation to cultural variation can flag aspects of text that deviates from a formal (and/or slang) used by native speakers of a given language. In various embodiments, the adaptation to cultural variation can flag aspects of text that deviates from the way the paragraphs are structured, the average lengths of the sentences, the opening and ending statements, and/or the number of repetitions of the ideas and/or certain words. In various embodiments, the adaptation to cultural variation can spend time learning in the background (e.g., from other tasks that are being processed).

Reference will now be made to a process (e.g., a network-based process) in which email and/or SMS location signatures are implemented. More particularly, a software application (according to various embodiments) can require a sender to allow verification of the location of transmission before a carrier forwards the email/message to the prospective recipient.

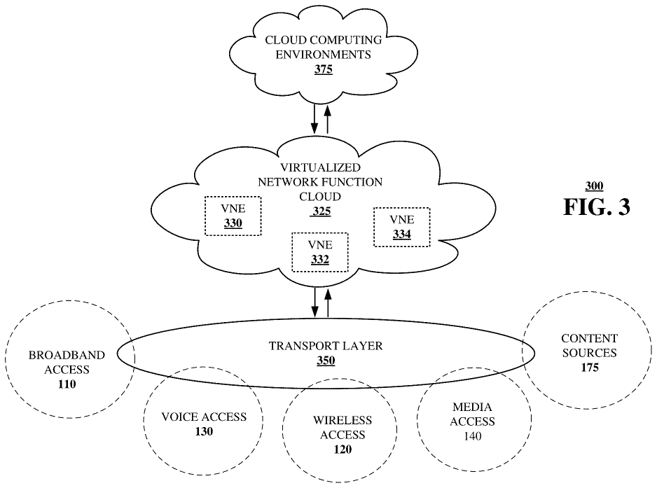

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, some or all of the subsystems and functions of system 200, some or all of the subsystems and functions of system 250, and/or some or all of the functions of methods 2000, 2100, 2200. For example, virtualized communication network 300 can facilitate in whole or in part unified wireless and wireline dynamic proxies (including, for example, a “bodyguard” (or master) digital proxy that interfaces with one or more other digital proxies and that follows a human user in the physical world and/or logically throughout a communications network).

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

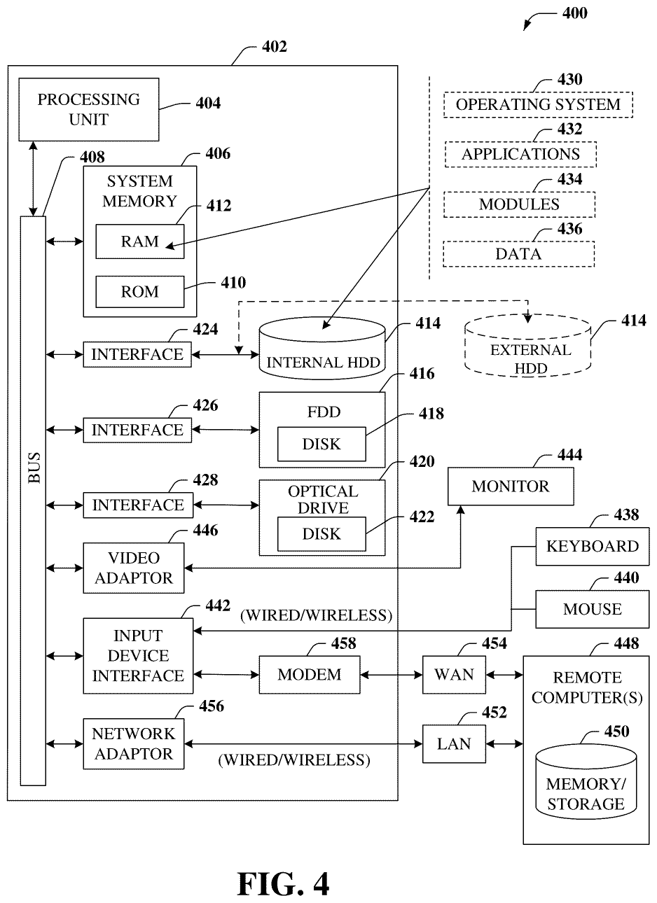

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part unified wireless and wireline dynamic proxies (including, for example, a “bodyguard” (or master) digital proxy that interfaces with one or more other digital proxies and that follows a human user in the physical world and/or logically throughout a communications network).

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

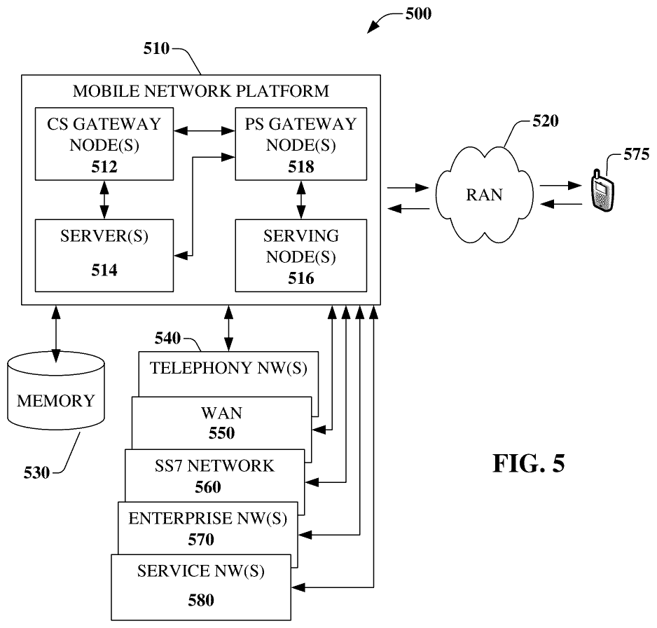

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part unified wireless and wireline dynamic proxies (including, for example, a “bodyguard” (or master) digital proxy that interfaces with one or more other digital proxies and that follows a human user in the physical world and/or logically throughout a communications network). In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

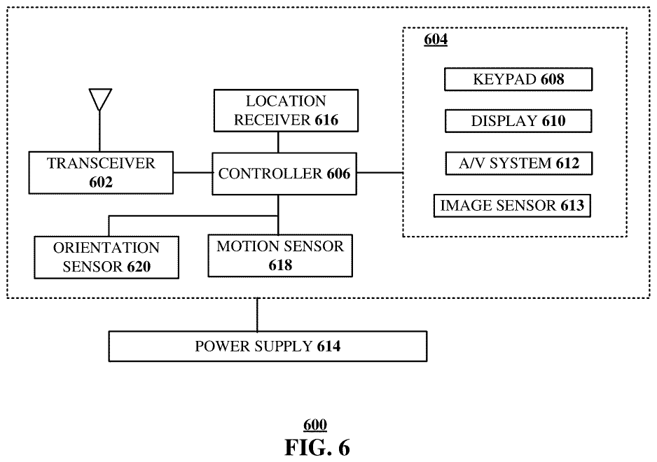

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part unified wireless and wireline dynamic proxies (including, for example, a “bodyguard” (or master) digital proxy that interfaces with one or more other digital proxies and that follows a human user in the physical world and/or logically throughout a communications network).

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBe® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically implementing unified wireless and wireline dynamic proxies (including, for example, a “bodyguard” (or master) digital proxy that interfaces with one or more other digital proxies and that follows a human user in the physical world and/or logically throughout a communications network)) can employ various AI-based schemes for carrying out various embodiments thereof. Moreover, a classifier can be employed to determine a ranking or priority of each user and/or each digital proxy. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the users and/or digital proxies is to receive priority.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
instantiating, on a communications system, a first master digital proxy associated with a first user;
identifying a first plurality of digital proxies, other than the first master digital proxy, that are on the communications system and that are associated with the first user;
responsive to the identifying, configuring the first master digital proxy for bi-directional communications with each of the first plurality of digital proxies;
determining movement of the first user, wherein the determining the movement of the first user comprises determining that a first user device being used by the first user has moved to communicating with a current network node of the communications system; and
responsive to the determining the movement of the first user, moving at least part of the first master digital proxy to the current network node of the communications system.

2. The device of claim 1, wherein the determining the movement of the first user further comprises determining that the first user device being used by the first user has physically moved from a prior location to a current location.

3. The device of claim 1, wherein the determining the movement of the first user further comprises determining that the first user device being used by the first user has logically moved from communicating with a prior network node of the communications system to the current network node of the communications system.

4. The device of claim 3, wherein each of the prior network node and the current network node comprises a respective one of: a base station; an eNodeB; a gNodeB; an access point; a router; a switch; an optical switch; or any combination thereof.

5. The device of claim 1, wherein the communications system comprises one of: a wireless communications system; a wired communications system; or any combination thereof.

6. The device of claim 5, wherein the wireless communications system comprises one of: a fourth generation (4G) cellular system; a fifth generation (5G) cellular system; a subsequent generation cellular system; or any combination thereof.

7. The device of claim 6, wherein the first user device comprises one of: a cellphone; a smartphone; a tablet computer; a laptop computer; a notebook computer; or any combination thereof.

8. The device of claim 5, wherein the wired communications system comprises a fiber optic communications system.

9. The device of claim 1, wherein the first master digital proxy is created via a generative artificial intelligence (AI) process.

10. The device of claim 1, wherein the first master digital proxy is updated, throughout a lifetime of the first user, via a generative artificial intelligence (AI) process.

11. The device of claim 10, wherein the first master digital proxy is updated based at least in part upon one or more transactions that are processed by the first plurality of digital proxies.

12. The device of claim 1, wherein the first master digital proxy and each of the first plurality of digital proxies comprises a respective one of: a software application; a large language model (LLM); or any combination thereof.

13. The device of claim 1, wherein the operations further comprise:
instantiating, on the communications system, a second master digital proxy associated with a second user;
identifying a second plurality of digital proxies, other than the second master digital proxy, that are on the communications system and that are associated with the second user;
responsive to the identifying of the second plurality of digital proxies, configuring the second master digital proxy for bi-directional communications with each of the second plurality of digital proxies;
determining movement of the second user, wherein the determining the movement of the second user comprises determining that a second user device being used by the second user has moved to communicating with another current network node of the communications system; and
responsive to the determining the movement of the second user, moving at least part of the second master digital proxy to the another current network node of the communications system.

14. The device of claim 1, wherein the bi-directional communications with each of the first plurality of digital proxies comprise oversight, by the first master digital proxy, of one or more transactions being processed by the first plurality of digital proxies.

15. The device of claim 14, wherein the oversight by the first master digital proxy comprises one of: verification of a transaction or party; authentication of a transaction or party; approval of a transaction or party; providing of a token for authentication; providing of a token for authorization; or any combination thereof.

16. The device of claim 15, wherein the authentication is based at least in part upon one of: a location of a party; a language used by a party; or any combination thereof.

17. A non-transitory machine-readable medium comprising executable instructions that, when executed by a processing system including a processor, facilitate performance of operations, the operations comprising:
configuring, on a communications system, a first master digital proxy associated with a first user, wherein the first master digital proxy is configured for first bi-directional communications with each of a first plurality of digital proxies that are associated with the first user;
configuring, on the communications system, a second master digital proxy associated with a second user, wherein the second master digital proxy is configured for second bi-directional communications with each of a second plurality of digital proxies that are associated with the second user;
tracking movement of the first user;
responsive to the tracking of the movement of the first user, relocating all or part of the first master digital proxy to a first target network node of the communications system that is in proximity to the first user;
tracking movement of the second user; and
responsive to the tracking of the movement of the second user, relocating all or part of the second master digital proxy to a second target network node of the communications system that is in proximity to the second user.

18. The non-transitory machine-readable medium of claim 17, wherein:
the relocating all or part of the first master digital proxy comprises relocating from a first source network node of the communications system;
the first user is utilizing first user equipment;
the first target network node is a node that is closer to the first user equipment than is any other node in the communications system;
the relocating all or part of the second master digital proxy comprises relocating from a second source network node of the communications system;
the second user is utilizing second user equipment; and
the second target network node is a node that is closer to the second user equipment than is any other node in the communications system.

19. A method, comprising:
tracking, by a processing system including a processor, first movement of a user of a communications network, wherein the tracking of the first movement results in a first determined location of the user;
responsive to the tracking of the first movement of the user, relocating by the processing system all or part of a master digital proxy to a first network node of the communications network that is in proximity to the first determined location, wherein the master digital proxy is configured for oversight of each of a plurality of digital proxies that are associated with the user;
tracking, by the processing system, second movement of the user, wherein the tracking of the second movement results in a second determined location of the user; and
responsive to the tracking of the second movement of the user, relocating by the processing system all or part of the master digital proxy to a second network node of the communications network that is in proximity to the second determined location.

20. The method of claim 19, wherein:
the tracking of the first movement of the user comprises tracking movement of an end-user device being used by the user;
the relocating to the first network node that is in proximity to the first determined location comprises determining that the first network node is within a threshold distance of the first determined location;
the relocating to the first network node comprises relocating all of the master digital proxy to the first network node;
the tracking of the second movement of the user comprises tracking movement of the end-user device being used by the user;
the relocating to the second network node that is in proximity to the second determined location comprises determining that the second network node is within the threshold distance of the second determined location; and
the relocating to the second network node comprises relocating all of the master digital proxy to the second network node.
